(19) United States
(12) Patent Application Publication
(10) Pub. No.: US 2015/0199334 A1
(43) Pub. Date: Jul. 16, 2015

(54) Automatic Generation of Coded Chief Complaints (CCCs)

(71) Applicant: Health Navigator, Inc., La Grange, IL (US)

(72) Inventor: David Thompson, La Grange, IL (US)

(73) Assignee: Health Navigator, Inc., La Grange, IL (US)

(21) Appl. No.: 14/155,210

(22) Filed: Jan. 14, 2014

(51) Int. Cl. G06F 17/28; G06F 19/00

(52) U.S. Cl. CPC G06F 17/28; G06F 19/32

(57) ABSTRACT

Embodiments described herein may involve systems and methods for automatic generation of coded chief complaints (CCCs) based on a spoken-language description of a “reason-for-call”. An example system may be any computing system such as a mobile device, a laptop, a stand-alone kiosk, or a network connected kiosk, among others. The system may generate CCC instances, based on the spoken-language description, which may help describe a patient's medical situation. The CCC instances may each have an acuity indicator that represents the level of urgency for a particular symptom, disease etc. In some cases, an overall acuity rating may be determined to represent the overall urgency of a patient's situation. The generated data may be sent to medical practitioners, stored for future review, and/or processed for data analysis, among other possibilities.

### BACKGROUND

Unless otherwise indicated herein, the materials described in this section are not prior art to the claims in this application and are not admitted to be prior art by inclusion in this section.

Computing devices such as personal computers, laptop computers, tablet computers, cellular phones, and countless types of Internet-capable devices are increasingly prevalent in numerous aspects of modern life. Over time, the manner in which these devices are providing information to users is becoming more intelligent, more efficient, more intuitive, and/or less obtrusive.

As computing devices become more intelligent, they may be used in every aspect of the medical field. As such, computing devices are becoming an increasingly popular way of allowing patients to play a role in improving the efficiency and quality of patient care. Computing devices may be particularly useful in documenting clinical presentation, identifying urgency and resource needs, determining patient expectations, and collecting valuable data.

### SUMMARY

Embodiments described herein may involve systems and methods for automatic generation of coded chief complaints (CCCs) based on a spoken-language description of a “reason-for-call” (RFC) or “reason for visit” (RFV). The spoken-language description content may be fairly crude, and thus may also be referred to as “conversational” user input or a natural-language description. Further, the spoken-language description may come in the form of speech input and/or a transcription of the speech (e.g., generated by a speech-to-text process).

Herein, a “chief complaint” may be the reason or one of the reasons that a patient is seeking and/or needs medical attention. Having clear documentation of a patient's chief complaints is valuable for reasons such as maintaining medical records, determining the urgency of a situation, and speeding up the process of providing medical assistance, among other possible reasons. In fact, eliciting a chief complaint is often one of the first tasks of medical personnel when a patient arrives.

Generally, medical personnel may determine and record the chief complaints for each encounter with a patient; however, this is usually done using the patient's own words and/or the medical personnel's interpretation of the patients words, thus leading to inconsistencies. Therefore, a comprehensive coded list of chief complaints may provide a reliable way to maintain consistency in determining the appropriate measures to assist a patient.

Accordingly, an example embodiment provides a list of “coded chief complaints” (CCCs). A CCC may be a data structure for a reason that a patient is seeking medical attention. A system that allows for automatic generation of CCCs using the patient's own words may therefore be useful for documenting clinical presentation, identifying urgency and resource needs, determining caller expectations, and providing a source of reliable data. An example system may be implemented as part of or take the form of any computing system, such as a laptop computer, a desktop computer, a tablet computer, a mobile phone, a stand-alone kiosk, or a network connected kiosk, among other possibilities.

A CCC instance may be a particular record having a structure of a CCC, which may be displayed to a user of the system. The system may generate one or more CCC instances based on a spoken-language description of a patient's medical situation. For example, each CCC instance would have an acuity indicator that represents the level of urgency for a particular symptom, disease etc. In some cases, an overall acuity rating may be determined to represent the overall urgency of a patient's situation. Further, a user of the system may provide additional notes to properly describe the situation at hand.

In some embodiments, the system may include an interface that displays the generated CCC instances and receives user-input (e.g., the patient's personal information). The interface may also provide access to additional screens, which may contain other valuable information. Further, the system may collect, store, and process any received and/or generated data. For instance, the data may be sent to medical practitioners, stored for future review, and/or processed for data analysis, among other possibilities.

As indicated above, the present application involves automatic generation of coded chief complaints (CCCs). In one aspect, a system is provided. The system includes an interface component and a computing system. The computing system is configured to cause the interface component to display a medical-diagnosis interface feature for receiving a reason-for-call description. In response to receiving the reason-for-call description, the computing system is then configured to use a natural-language mapping between a plurality of reason-for-call expressions and a finite set of coded chief complaints (CCCs) to generate one or more CCC instances that correspond to the reason-for-call description, where each of the coded chief complaints (CCCs) corresponds to one or more reason-for-call expressions from the plurality of reason-for-call expressions, and where each of the one or more CCC instances comprises a complaint descriptor, a type indicator, and a body-system indicator. Further, the computer system is then configured to cause the interface component to display at least a portion of the one or more CCC instances via the medical-diagnosis interface feature.

In another aspect, a non-transitory computer readable medium is provided. The non-transitory computer readable memory has stored thereon instructions executable by a computing device to cause the computing device to perform functions. The functions include receiving a reason-for-call description, where the reason-for-call description is generated via an interface. The functions also include using a natural-language mapping between a plurality of reason-for-call expressions and a finite set of coded chief complaints (CCCs) to generate one or more CCC instances that correspond to the reason-for-call description, where each of the coded chief complaints (CCCs) corresponds to one or more reason-for-call expressions from the plurality of reason-for-call expressions, and where each of the one or more CCC instances comprises a complaint descriptor, a type indicator, and a body-system indicator. Further, the functions also include initiating a process to display at least a portion of the one or more CCC instances via the interface.

In yet another aspect, a method is provided. The method involves receiving a reason-for-call description, where the reason-for-call description is generated via an interface. The method also involves using a natural-language mapping between a plurality of reason-for-call expressions and a finite set of coded chief complaints (CCCs) to generate one or more CCC instances that correspond to the reason-for-call description, where each of the coded chief complaints (CCCs) corresponds to one or more reason-for-call expressions from the plurality of reason-for-call expressions, and where each of the one or more CCC instances comprises a complaint descriptor, a type indicator, and a body-system indicator. The method further involves initiating a process to display at least a portion of the one or more CCC instances via the interface.

These as well as other aspects, advantages, and alternatives will become apparent to those of ordinary skill in the art by reading the following detailed description, with reference where appropriate to the accompanying drawings.

### BRIEF DESCRIPTION OF THE DRAWINGS

FIG. 1 is a flowchart showing a process for generating and utilizing coded chief complaints (CCCs).

FIG. 2 is an example configuration in which example embodiments may be practiced.

FIG. 3A is a functional block diagram of an example computing device.

FIG. 3B is a functional block diagram of an example computing device having an external server.

FIG. 4 is a functional block diagram of two example computing devices in communication.

FIG. 5 is an interface according to an example embodiment.

FIG. 6 is an illustration demonstrating example generation of CCC instances.

FIG. 7 is an illustration of CCC instances displayed in an interface according to an example embodiment.

FIG. 8 is an example graph demonstrating syndromic surveillance.

### DETAILED DESCRIPTION

Example methods and systems are described herein. It should be understood that the words “example,” “exemplary,” and “illustrative” are used herein to mean “serving as an example, instance, or illustration.” Any embodiment or feature described herein as being an “example,” being “exemplary,” or being “illustrative” is not necessarily to be construed as preferred or advantageous over other embodiments or features. In the following detailed description, reference is made to the accompanying figures, which form a part thereof. In the figures, similar symbols typically identify similar components, unless context dictates otherwise. Other embodiments may be utilized, and other changes may be made, without departing from the spirit or scope of the subject matter presented herein.

The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

### A. SYSTEMS FOR AUTOMATIC GENERATION OF CODED CHIEF COMPLAINTS (CCCs)

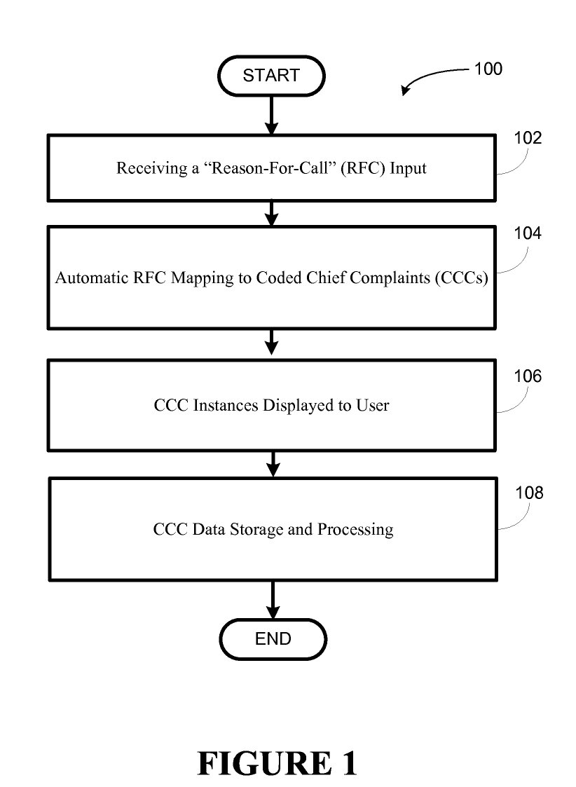

FIG. 1 is a flowchart illustrating a process 100, according to an example embodiment. In particular, process 100 may be implemented to automatically generate, display, and/or store instances of coded chief complaints (CCCs) based on spoken natural-language descriptions of patients' issues. Process 100 may be implemented in any computing device, such as a laptop, a mobile phone, a tablet, a kiosk, and/or other types of computing devices.

At block 102, the process 100 involves receiving “reason-for-call” (RFC) or “reason for visit” (RFV) input. The RFC input may be received via any computing system and in any configuration. Further, the RFC input may include a spoken-language description of a patient's condition or situation. The description may be received from any user of the computing device such as the patient himself, a family member, a doctor, or a nurse, among other possibilities. Additionally, the RFC input may be entered by typing (i.e., text) and/or by speaking (i.e., speech).

Note that a speech input may be converted to text or may be processed as audio. In some cases, every spoken word may be converted to text. In other words, the spoken-language description may appear in text as spoken by the user. In another case, the system may intelligently convert the spoken-language description into formally written text. Other cases may also be possible. Also, note that such a spoke-language description may also be referred to as “conversational” input or a natural-language description.

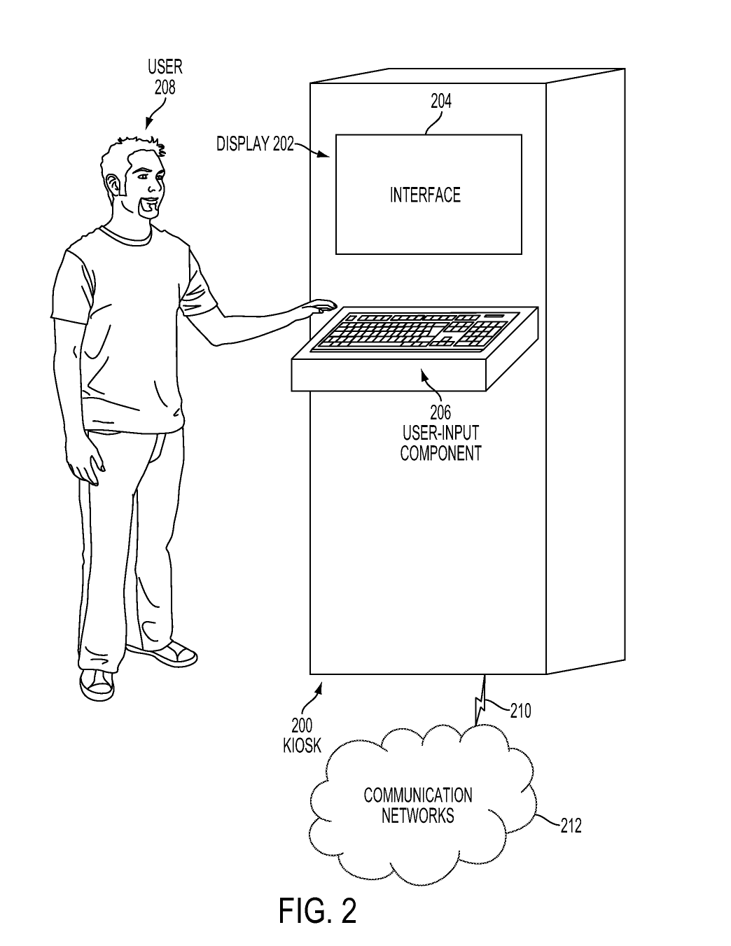

FIG. 2 shows an example configuration in which process 100 of FIG. 1 may be implemented. The configuration shows a kiosk 200 that includes a display 202 (may also be referred to as an interface component) and a user-input component 206 that is capable of receiving the RFC input. User-input component 206 may be any device, such as a keyboard or a microphone, through which the above described RFC input may be received. Additionally, display 202 may be capable of displaying an interface 204, such as a medical-diagnosis interface feature, which may be used to guide a user 208 through the process providing user-input (such as the RFC input).

In some cases, kiosk 200 may be a stand-alone kiosk. In other words, the kiosk may operate independently of any other computing system. In other cases, kiosk 200 may be a network connected kiosk as shown in FIG. 2. In particular, kiosk 200 may connect to any number of communication networks 212 via link 210 and thus may be in communication with other computing systems.

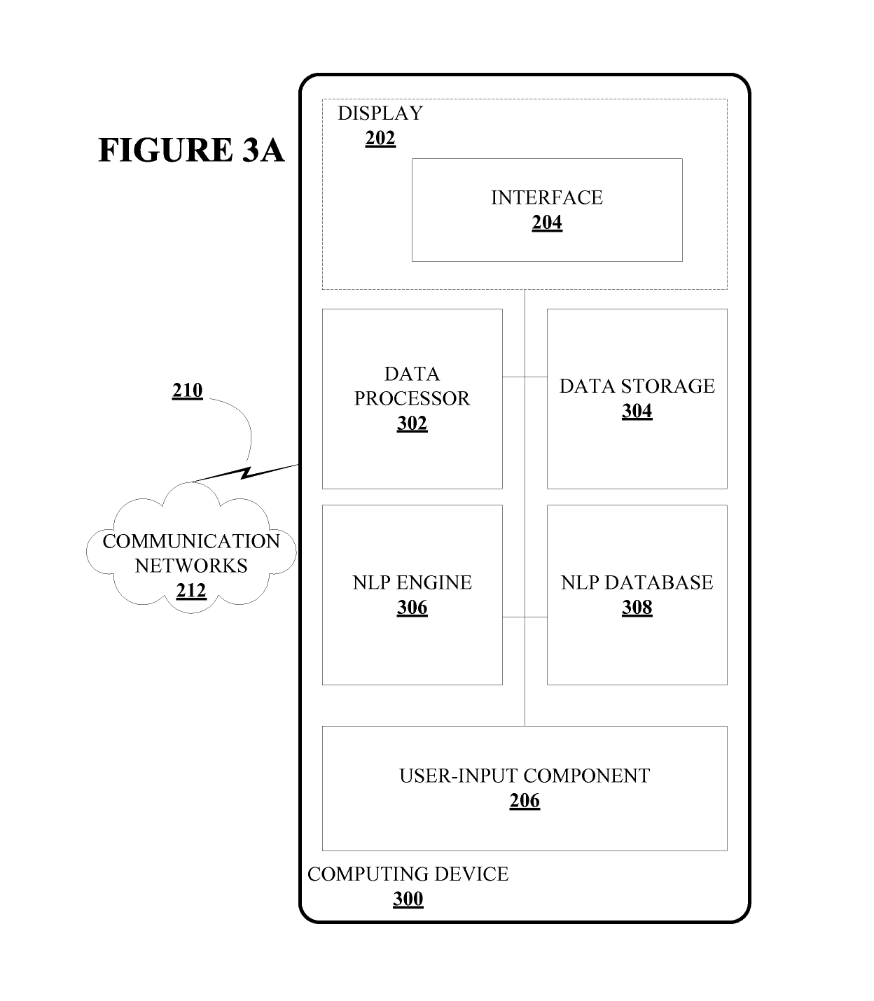

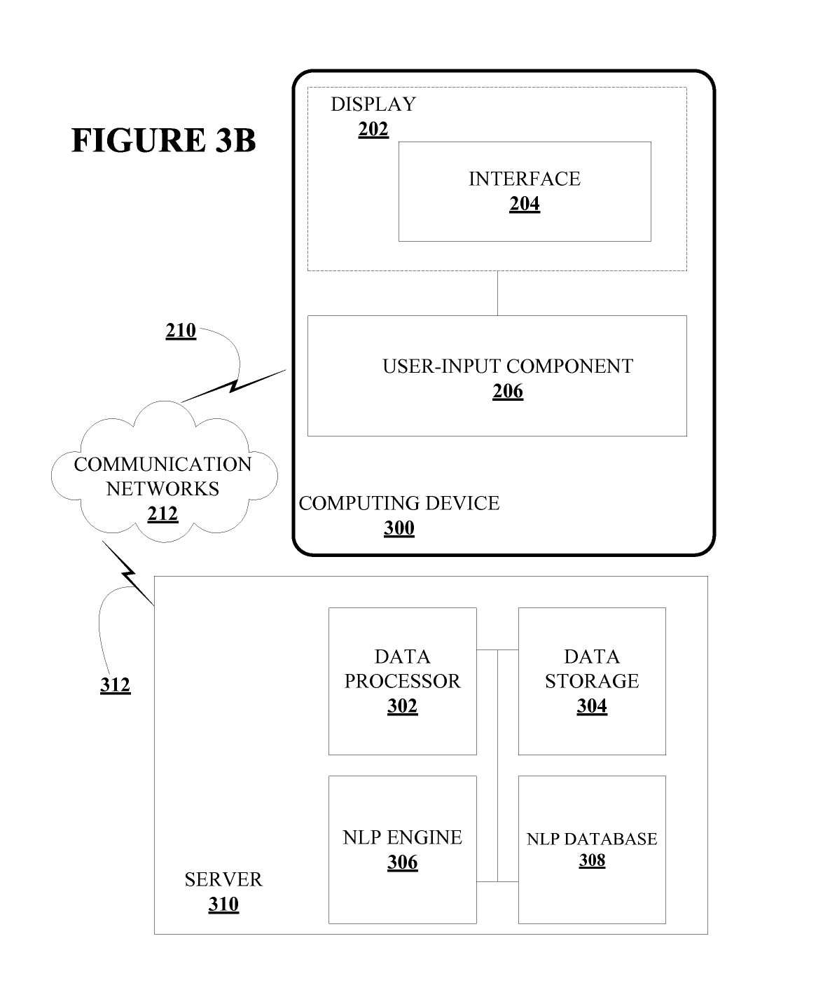

In some embodiments, process 100 of FIG. 1 may be practiced in a configuration including a computing device such as a mobile phone, laptop, or tablet, among other possibilities. For instance, similarly to kiosk 200 of FIG. 2, FIG. 3A shows a computing device 300 that also includes a display 202 (capable of displaying interface 204), a user-input component 206, and the ability to connect to any number of communication networks 212 via a link 210. The computing device 300 may further include a data processor 302, data storage 304, a natural-language processing (NLP) engine 306, and NLP database 308. Note that, as illustrated in FIG. 3A, all the components of computing device 300 may be in communication with each other.

In another embodiment, as shown in FIG. 3B, some components of computing device 300 may be located in an external server 310. In particular, FIG. 3B shows computing device 300 connected to a communication network 212 via link 210. The communication network 212 may initiate a connection with server 310 via link 312 thus establishing a communication between computing device 300 and server 310. As shown, server 310 may include the data processor 302, data storage 304, the NLP engine 306, and/or NLP database 308, among other possibilities. Note that links may represent wireless and/or wired communication.

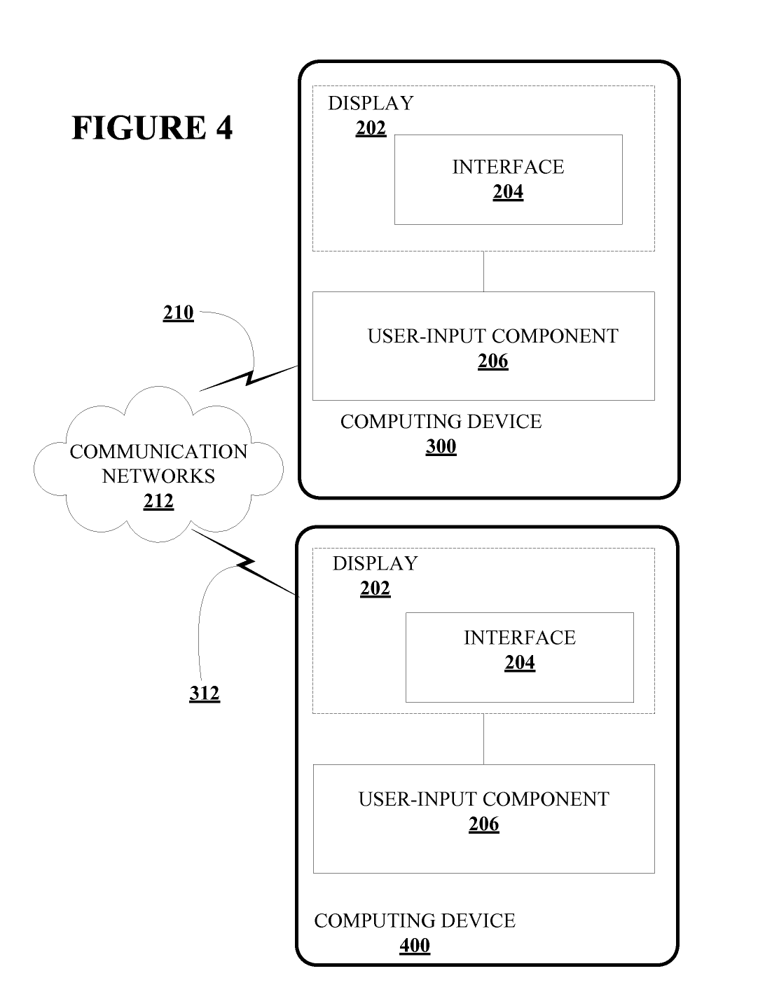

In some cases, information gathered and generated on one computing device may be sent to any number of additional computing devices. For example, the system may be designed to forward any patient information to any number of doctors and nurses. To illustrate, consider computing devices 300 and 400 as shown in FIG. 4. The devices may communicate with each other via any number of communication networks 212. Note that either of the devices may be capable of receiving the RFC input and that the computing devices may also be a kiosk as described above in reference to FIG. 2.

In some embodiments, the server 310 that hosts NLP engine 306 may be a secure server. Accordingly, communications between computing devices 300 and server 310 may be conducted under a secure communication protocol. Further, an application programming interface (API) may be provided that allows various applications to interface with the NLP engine 306. For example, an API may be provided that allows a web-based application to send communicate with server 310 to, e.g., send queries to, and receive corresponding CCC instances from, the NLP engine 306. In some implementations, a website that utilizes the API and JavaScript (or another scripting language) may provide an application for accessing the NLP engine 306 that can be accessed through web browsers on various different types of devices (e.g., through different types of web browsers on mobile phones, tablets, and/or laptop or desktop computers).

### B. AUTOMATIC REASON FOR CALL (RFC) MAPPING TO CODED CHIEF COMPLAINTS (CCCs)

At block 104, process 100 further involves automatic RFC mapping to CCCs. The mapping occurs based on the RFC input received via the medical-diagnosis interface.

(i) Example Interface

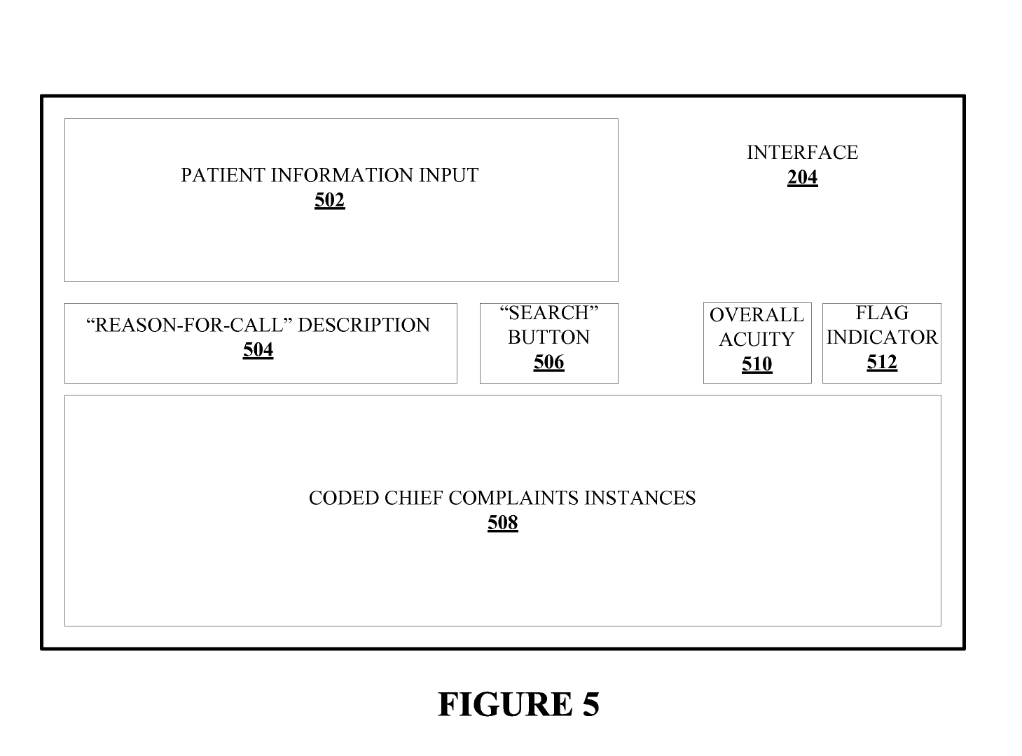

FIG. 5 shows an example interface 204 in which process 100 may be practiced. The interface may be interface 204 as described above in reference to FIGS. 2, 3A, 3B, and 4 or may be any other interface in which process 100 may be practiced.

In one case, interface 204 may include a field (i.e., a box or an area) to receive patient information input 502. The patient information may include but is not limited to: first name, last name, date of birth, gender, age, phone number, previous medical conditions, previous medical operations, prescribed medication, and known allergies. Note that the received information may be forwarded to other computing devices as mentioned above and/or stored along with CCC instances as part of a record for a patient.

As described above, the system may receive RFC input from a user of the system. Therefore, the interface 204 may also include a field to receive a “reason-for-call” description 504 (i.e., the RFC input) via text and/or speech input. As noted above, the RFC input may include a spoken-language description of a patient's condition or situation. In other words, the user can provide such a description without using any special terms or phrases; the user can simply describe their problem in a conversational manner.

Subsequent to the system receiving the patient information 502 and the “reason-for-call” description 504, the system may receive user-input indicating a user's request to initiate the process of mapping the RFC input to CCCs (e.g., by clicking a “search” button 506). In some cases, a request to “search” may come in the form of a voice command, among other possibilities.

In some embodiments, as will be further discussed below, interface 204 may also include an option to generate and/or select an acuity rating for each CCC instances 508, an overall acuity rating 510, as well as select a flag indicator 512. Further, interface 204 may also provide access to any number of additional interface screens that may include any relevant information regarding the patient, medical facilities, doctors, and detailed descriptions of CCCs, among other possibilities.

(ii) Example Input and CCC Instances

In response to receiving a “reason-for-call” description 504, an NLP engine (such as engine 306 mentioned above) may carry out natural-language mapping between reason-for-call expressions found in the “reason-for-call” description 504 and a set of coded chief complaints (CCCs) stored in an NLP database (such as database 308 mentioned above). The natural-language mapping may then be used to generate any number of coded chief complaints (CCC) instances 508 that correspond to the “reason-for-call” description.

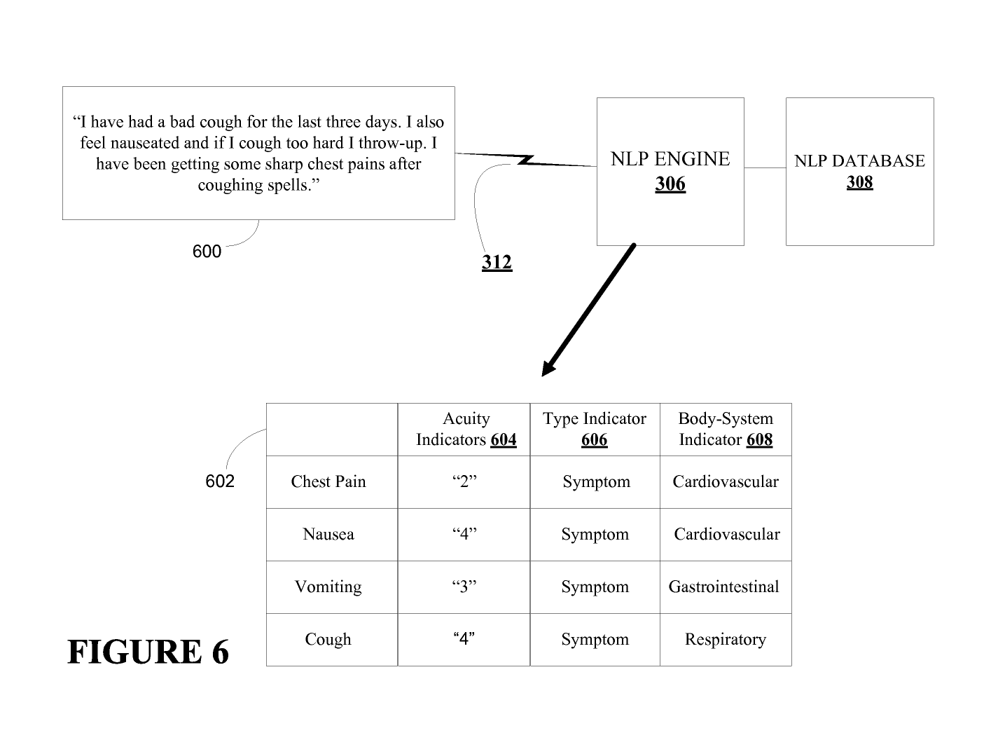

To illustrate, consider FIG. 6 showing an NLP Engine 306 processing an example RFC description 600 to generate example CCC instances 602. This may occur in a situation where a patient using the interface enters patient information along with a “reason-for-call” description. For instance, as shown in the example RFC description 600, the patient may say “I have had a bad cough for the last three days. I also feel nauseated and if I cough too hard I throw-up. I have been getting some sharp chest pains after coughing spells.” After receiving an indication that a user clicked the “search” button, the system may generate example CCC instances 602 such as: “Chest Pain”, “Nausea”, “Vomiting”, and “Cough”.

Note that other examples may also be possible. For instance, the patient may say “I got into a minor car accident last night. I have a cut on my leg and my back has been hurting.” After receiving an indication that user clicked the “search” button, the system may generate CCC instances such as: “Motor Vehicle Accident”, “Cut-Laceration”, and “Back Pain”.

(iii) Generation of CCC Instances

As shown in FIG. 6, each example CCC instance 602 may have a type indicator 606 and a body-system indicator 608. A type indicator 606 may represent the patient's situation associated with a CCC instance (e.g., symptom, injury, disease). A body-system indicator 608 may represent the part of the human body associated with a symptom, injury, disease etc. (e.g., respiratory, eyes, cardiovascular). For example, as shown in FIG. 6, a CCC instance of “cough” may have a type indicator of “symptom” and a body-system indicator of “respiratory”.

In some embodiments, a CCC instance may have an acuity indicator 604. An acuity indicator 604 represents the level of urgency corresponding to a CCC instance. The level of urgency may be selected from two or more levels of urgency. Further, each level of urgency may be represented by any combination of a color, a number, a title, and/or a description, among others. For example, each CCC instance can have an acuity indicator representing one of the following levels of urgency: Life-threatening, High Risk, Moderate Risk, Low Risk, and No symptoms. A high level of urgency (e.g., Life-threatening) may be represented by a number such as “5” or the color red. On the other hand, a low level of urgency (e.g., Low Risk) may be represented by a number such as “2” or the color green. Showing an acuity indicator 604 may help determine the degree of harm for a patient's condition, whether immediate treatment is needed, and/or the extent of resources needed to intervene.

In one case, the acuity indicator 604 for each CCC instance may be predetermined. For example, each CCC instance that is stored in a database 308 may have a corresponding acuity indicator 604. Further, the acuity (i.e., urgency) may be coded according to various protocols such as Call Priority Index (CPI), ICD9, and ICD 10, among others.

In another case, the acuity indicator 604 may be determined based on a context. In one example, the acuity indicator 604 may be determined based on the spoken-language description. To illustrate, consider a situation where a patient writes: “I have been coughing occasionally over the past few days”. In this situation, a CCC instance 508 of “cough” with an acuity indicator 604 in a shade of green (e.g., Low Risk) may be determined. However, in a situation where a patient writes: “I have been coughing non-stop over the past few days”, an acuity indicator 604 in a shade of yellow (e.g., Moderate Risk) may be determined. In other words, the severity of the CCC instance 508 may change the acuity indicator 604. In another example, a patient's medical history may help determine the acuity indicator 604. For instance, a patient that is known to suffer from asthma may have a higher acuity for a CCC instance 508 of “cough”. In yet another example, a patient may individually select an acuity rating for each generated CCC instance 508. Other examples may also be possible.

### C. DISPLAYING CODED CHIEF COMPLAINTS (CCC) INSTANCES

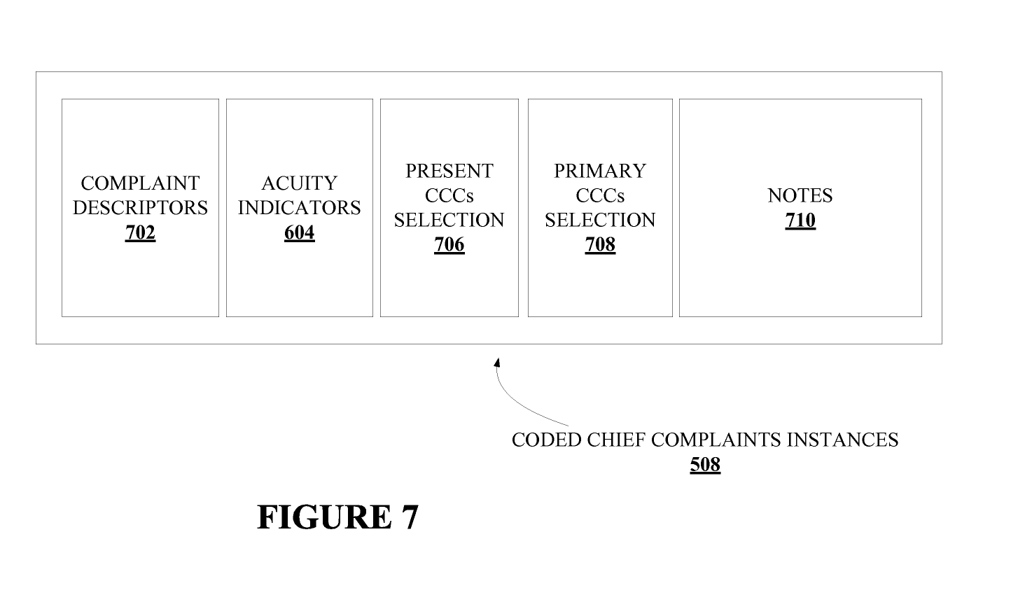

At block 106, process 100 further involves displaying the generated CCC instances to a user of the system. Note that the system may display any portion of the generated CCC instances 508. Further, as shown in FIG. 7, the generated CCC instances 508 may include several elements that may be presented to a user of the system. The elements may include acuity indicators 604, type indicators 606, and/or a body-system indicators 608 as described in accordance with FIG. 6; as well as complaint descriptors 702, a present CCCs selection field 706, a primary CCCs selection field 708, and user notes 710. Other elements may also be possible. Note that the elements discussed herein may be displayed anywhere in the CCC instances 508 section of interface 204 or may be accessed through additional screens.

Complaint descriptors 702 may provide useful information about each CCC instance. The information may include the name of a symptom, a disease, or a condition, among others. Additionally, a complaint descriptor 702 may provide information regarding available treatment options, specialized practitioners, images, third-party resources etc. Further, any of the information associated with the complaint descriptors 702 may be presented to a user of the system via interface 204. Alternatively, as discussed above, additional screens containing the information may be accessed from interface 204. In some embodiments, as shown in FIG. 5, an overall acuity rating 510 may be determined or selected. In one case, the system may receive an indication that a user has selected an overall acuity rating 510 to represent the level of urgency for the patient's situation as a whole, rather than for a specific symptom or disease. In another case, an overall acuity rating 510 is generated based on a context, such the spoken-language description or a patient's medical history, as described above in association with determining an acuity indicator 604.

In yet another case, an overall acuity rating 510 may be determined based on the determined acuity indicators 604, type indicators 606, and/or body-system indicators 608. In one example, the overall acuity rating 510 may be an average of all or some of the acuity indicators 604. In another example, the overall acuity rating 510 may be a weighted average of all or some of the acuity indicators 604. That is, each CCC instance 508 may hold a “weight” depending on the severity and frequency of the symptom, disease etc. Therefore, a CCC instance 508 such as “cough” may hold more “weight” than a CCC instance 508 such as “hoarseness” and may consequently have more influence on the overall acuity rating 510. Further, note that the type indicators 606 and the body-system indicators 608 may also have a “weighted” influence on the overall acuity rating 510. Other examples may also be possible.

In some embodiments, such as the embodiment shown in FIG. 5, a flag indicator 512 may be selected or “checked” in a “High Risk” or “Life-Threatening” situation. In one case, a flag indicator 512 may be automatically selected if a high overall acuity rating 510 is determined. In another case, a flag indicator 512 may be automatically selected if one or more CCC instances 508 have an acuity indicator 604 representing a high level of urgency. In yet another case, the system may receive an indication that a flag indicator 512 has been “checked” by a user of the system. Other cases may also be possible.

In response to the selection of a flag indicator 512, the system may take action to assist the patient. In one example, the system may alert medical personnel of the patient's situation. In some cases, the appropriate medical personnel may be determined based on the patient information 502. In another example, the system may request an ambulance to arrive. Other examples may also be possible

In some embodiments, such as the embodiment shown in FIG. 7, interface 204 may include features that allow for present CCCs selection 706, primary CCCs selection 708, and/or receiving notes 710. In particular, subsequent to generation of CCC instances 508, a user may provide a selection via selection feature 706 (which may be in the form of a checkbox) that indicates which of the generated CCC instances 508 are actually relevant to a patient's particular situation. Additionally, a user may provide a selection via selection feature 708 that indicates which of the generated CCC instances 508 are most significant to a patient's particular situation. Further, the user may also provide additional notes via notes feature 710 that may be used to further illustrate a patient's situation. A note may be entered for each CCC instance 508, a portion of the CCC instances 508, all of the CCC instances 508, and/or in a separate section. Yet further, a spoken-language description may similarly be used to enter the notes by text and/or speech.

### D. CODED CHIEF COMPLAINTS (CCC) DATA STORAGE AND PROCESSING

At block 108, process 100 further involves storage and/or processing of CCC instances that were generated at block 106. As discussed above in association with FIGS. 3A and 3B, any data that is collected or generated may be stored in data storage 304 and processed by data processor 302. The data may be used for patient records, reporting, documentation, analysis, surveillance, quality assurance, benchmarking, research, education, and modeling, among other possibilities.

Various methods may be used to store and organize the data discussed herein. For example, stored CCC instances may correspond to patient information, time of entry, date of entry, acuity rating, medical history, selected present CCCs, selected primary CCCs, and/or user notes, among others. Additionally, any data may be entered or removed at any time. Further, any data addition or removal may be done automatically or may be done manually.

Various methods may also be used to process the stored data. For instance, the data may be used for syndromic surveillance. Syndromic surveillance may involve techniques for tracking and analyzing public health over time. Consequently, data provided via such techniques may help prevent outbreaks by early detection and analysis of health trends that indicate such outbreaks. As a result, each CCC may be coded for syndromic surveillance under selected protocols and regulations.

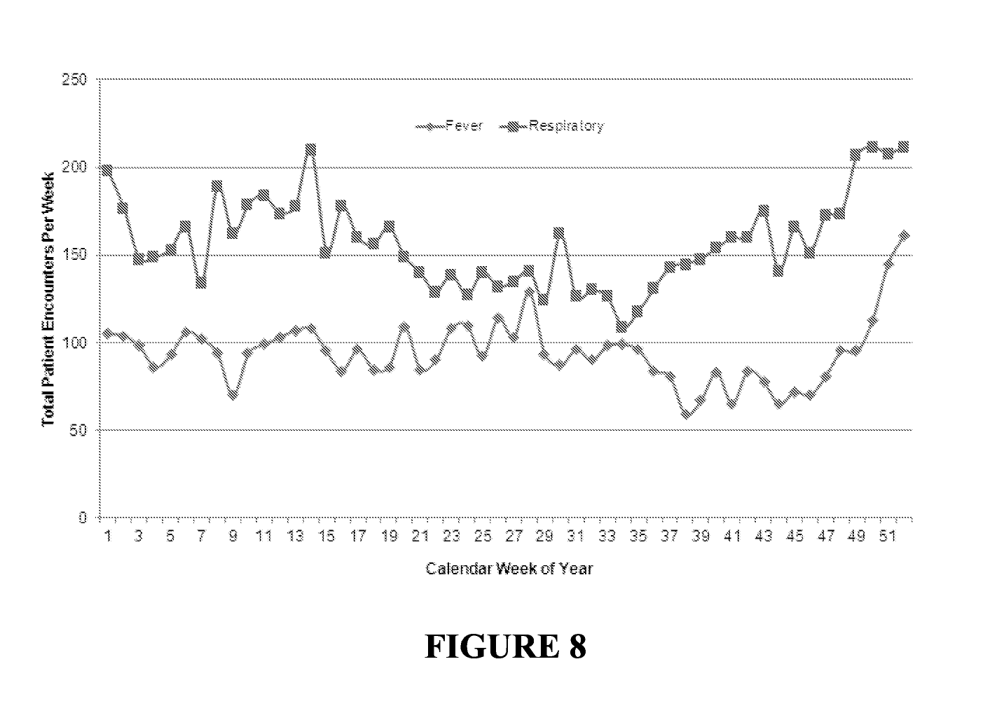

For example, consider FIG. 8 showing an example graph used for syndromic surveillance. FIG. 8 shows the “total patient encounters per week” over the course of a year (i.e., calendar week of year) associated with a particular CCC instance. In this case, data is shown for the CCC instance titled “fever”. The data shown in the graph indicates that in the 13^{th} week of a calendar year there was a large increase in the number of encounters generating the CCC instance titled “fever”. Therefore, such data may help determine the time of the year when a “fever” is most prevalent, among other possibilities. Note that, as shown in FIG. 8, data used for syndromic surveillance may also include type indicators and body-system indicators (e.g., respiratory). Also, note that this example is used for illustration purposes only and is not meant to be limiting. Other examples may also be possible.

In some embodiments, output may be generated to predict a public health event. In particular, the system may aggregate the CCC instances and store the data in data storage 304. The aggregated data may then be analyzed by the system in order to predict a public health event as discussed above in association with FIG. 8. In a case when a system predicts a public health event, the system may alert patients and/or medical practitioners, among other possibilities.

In some embodiments, output may be tabulated to monitor compliance with Centers for Medicare and Medicaid Services (CMS) documentation requirements. An example includes using system indicator to check for CMS Review of Systems documentation requirements.

### E. CONCLUSION

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

Moreover, a block that represents one or more information transmissions may correspond to information transmissions between software and/or hardware modules in the same physical device. However, other information transmissions may be between software modules and/or hardware modules in different physical devices

1. A system comprising:
an interface component; and
a computing system configured to:
cause the interface component to display a medical-diagnosis interface feature for receiving a reason-for-call description, wherein the reason-for-call description comprises a single natural-language input;
in response to receiving the reason-for-call description, use a natural-language mapping between a plurality of reason-for-call expressions and a finite set of coded chief complaints (CCCs) to select, from the finite set, a subset of two or more CCCs that correspond to the single natural-language input of the reason-for-call description, wherein each of the CCCs corresponds to one or more reason-for-call expressions from the plurality of reason-for-call expressions, and wherein the finite set of CCCs comprises CCCs corresponding to a plurality of CCC types comprising a symptom type, a disease type, and an injury type;
generate a CCC instance that corresponds to each CCC from the subset, wherein each of the one or more CCC instances comprises a complaint descriptor, a type indicator indicating the corresponding CCC type from the plurality of types, and a body-system indicator; and
cause the interface component to display at least a portion of the one or more CCC instances via the medical-diagnosis interface feature.

2. The system of claim 1, wherein each of the one or more CCC instances further comprises an acuity indicator.

3. The system of claim 2, wherein the acuity indicator is presented via the medical-diagnosis interface feature by one or more of: (i) a color, (ii) a number, (iii) a title, and (iv) a description.

4. The system of claim 2, wherein the acuity indicator corresponds to a level of urgency, wherein the level of urgency is selected from two or more levels of urgency.

5. The system of claim 4, wherein the two or more levels of urgency comprise two or more of: (i) Life-Threatening, (ii) High Risk, (iii) Moderate Risk, (iv) Low Risk, and (v) No Symptoms.

6. The system of claim 1, wherein the system is implemented as part of or takes the form of a stand-alone kiosk or a network-connected kiosk.

7. The system of claim 1, wherein the system is implemented as part of or takes the form of a computing device, and wherein the medical-diagnosis interface feature is presented on a graphic display of the computing device.

8. The system of claim 7, wherein the computing device is one of a laptop, a personal computer, a tablet computer, or mobile device.

9. The system of claim 1, wherein the computing system is further configured to:
cause the interface component to display the medical-diagnosis interface feature for receiving patient information.

10. The system of claim 9, wherein the computing system is further configured to:
send the received patient information and one or more of the CCC instances to another computing device.

11. The system of claim 1, wherein the computing system is further configured to:
store one or more of the CCC instances on a server.

12. The system of claim 11, wherein the stored CCC instances correspond to at least one or more of: (i) patient information, (ii) time of entry, (iii) location of entry, (iv) acuity rating, and (v) additional medical terms.

13. The system of claim 1, wherein the computing system is further configured to:
subsequent to causing the interface component to display at least a portion of the one or more CCC instances via the medical-diagnosis interface feature, select, based on a user-input via the interface component, one or more present coded chief complaints (CCCs) from the one or more CCC instances.

14. The system of claim 1, wherein the computing system is further configured to:
subsequent to causing the interface component to display at least a portion of the one or more CCC instances via the medical-diagnosis interface feature, select, based on a user-input via the interface component, one or more primary coded chief complaint (CCC) from the one or more CCC instances.

15. (canceled)

16. (canceled)

17. The system of claim 1, wherein the reason-for-call description is received based on a user-input via the interface component, where the user-input comprises one or more of: (i) speech and (ii) text.

18. A non-transitory computer readable medium having stored therein instructions executable by a computing device to cause the computing device to perform functions comprising:
receiving a reason-for-call description, wherein the reason-for-call description is generated via an interface, wherein the reason-for-call description comprises a single natural-language input;
using a natural-language mapping between a plurality of reason-for-call expressions and a finite set of coded chief complaints (CCCs) to select, from the finite set, a subset of two or more CCCs that correspond to the single natural-language input of the reason-for-call description, wherein each of the CCCs corresponds to one or more reason-for-call expressions from the plurality of reason-for-call expressions;
generating a CCC instance that corresponds to each CCC from the subset wherein each CCC instance comprises a complaint descriptor, a type indicator, and a body-system indicator; and
initiating a process to display at least a portion of the one or more CCC instances via the interface.

19. A method comprising:
receiving, by a computing device, a reason-for-call description, wherein the reason-for-call description is generated via an interface, wherein the reason-for-call description comprises a single natural-language input;
using, by the computing device, a natural-language mapping between a plurality of reason-for-call expressions and a finite set of coded chief complaints (CCCs) to select, from the finite set, a subset of two or more CCCs that correspond to the single natural-language input of the reason-for-call description, wherein each of the CCCs corresponds to one or more reason-for-call expressions from the plurality of reason-for-call expressions;
generating, by the computing device, a CCC instance that corresponds to each CCC from the subset, wherein each CCC instance comprises a complaint descriptor, a type indicator, and a body-system indicator; and
initiating, by the computing device, a process to display at least a portion of the one or more CCC instances via the interface.

20. The method of claim 19, wherein the finite set of coded chief complaints (CCCs) comprises CCCs corresponding to a plurality of types, wherein the plurality of types comprise a symptom type, a disease type, and an injury type.

21. The method of claim 19, further comprising a computing system configured to:
aggregating and storing generated CCC instances corresponding to a plurality reason-for-call descriptions;
analyzing the aggregated CCC instances over time to detect at least one health trend; and
in response to detection of the at least one health trend, outputting an indication that the at least one health trend has been detected.

22. The method of claim 19, further comprising a computing system configured to:
aggregating and store generated CCC instances corresponding to a plurality reason-for-call descriptions;
analyzing the aggregated CCC instances over time to predict at least one future health trend; and
in response a prediction of the at least one future health trend, outputting an indication that the at least one future health trend is predicted.
